(19) United States
(12) Patent Application Publication
(10) Pub. No.: US 2015/0007432 A1
(43) Pub. Date: Jan. 8, 2015

(54) Modular RJ Connector Latch Replacement

(71) Applicant: Tavinder S. Rehsi, Slough (GB)

(72) Inventor: Tavinder S. Rehsi, Slough (GB)

(21) Appl. No.: 14/295,629

(22) Filed: Jun. 4, 2014

Related U.S. Application Data
(60) Provisional application No. 61/843,353, filed on Jul. 6, 2013.

(51) Int. Cl. H01R 43/00

(52) U.S. Cl. CPC H01R 43/002
USPC 29/729; 29/876

(57) ABSTRACT

A method of repairing damaged RJ-type connectors that have a broken latch includes providing a forward-facing connector latch arm replacement device. The device includes a dual-action T-piece having a T shaped distal end with a narrow waist section linking to the proximal end and a C-spring coupled to the proximal end whereby the C-spring enables selective deflection of the T-piece whereby the narrow waist selectively engages and disengages the locking lugs provided by the RJ-type connector plug. The C-spring further includes a base configured offset from and opposite to the distal end. The device also includes a means for coupling the connector latch replacement device to the RJ-type connector.

### PRIORITY CLAIM

The present application claims benefit under 35 USC Section 119(e) of U.S. Provisional Patent Application Ser. No. 61/843,353 filed on 2013 Jul. 6: The present application is based on and claims priority from this application, the disclosure of which is hereby expressly incorporated herein by reference.

### FIELD OF THE INVENTION

The present invention relates to the technical field of data communications, computers, CCTV and other digital communications, and in particular replacing the broken latch of a modular RJ type plug.

### BACKGROUND

At present, connectors such as the RJ45, RJ11 and other related modular connectors types are widely used in computer networks, broadband data networks and CCTV amongst other uses. The weak point in the existing connectors is the locking tab (or latch, or latch-arm); being plastic and given that it faces rearward, standing proud from the socket itself—making it susceptible to being snagged—it breaks at its anchor point, or loses its elasticity and the connector then makes poor intermittent contact with the socket or falls out of the socket.

In most cases broken tabs or loose connectors cause intermittent communication issues that cost businesses a lot of money and also wastes a lot of time on calls to call centers and IT departments when they go faulty. As mobile workers continuously wrap and unwind their communication cables, the unwinding and pulling the leads apart also causes the rearward-facing latch to snag and thus break as the prior connectors latching arm gets caught easily as described below.

The present options are to either replace the whole cable, or change the connector with the broken latch: This involves expensive tools and costly, skilled technician hours on site. Replacing the connector at the end of a long cable is sometimes the only viable method, especially in expensive long run cables or looms that cannot be easily accessed as in network server cabinets etc. This is cumbersome and sometimes takes a few attempts to wire up correctly and only if there is sufficient cable length to enable stripping the cable back etc. FIGS. 60 and 61 show the prior RJ45 and RJ11 connectors with their latch arms and FIGS. 64 and 65 show the prior connectors with the broken latch arms.

### SUMMARY OF THE INVENTION

The invention provides a simple means to resolve the problem of the broken latch on RJ type connectors quickly with minimal skills.

One embodiment made of a fixed dimension and form of this present invention is shown in FIGS. 1-4 it can be used on almost all the range of RJ type modular connectors (large and small) using the stick on method with no changes, hence it can be deemed as a universal fix device for RJ-type connectors. Another benefit of this stick on method is that the top profile of the invention is the same dimension as the central slot of the socket. This means that there is no protrusions of metal or plastic beyond the RJ connectors top surface so it can be used in situations where the socket is sunk deep into the body of its host and there is no tolerance for any add on devices that will make the side or top walls of the RJ modular connector any wider or thicker in the socket.

Due to the evolution of this invention, in particular, the C-spring versions, which allow those with limited manual dexterity to press down the latch more easily (FIG. 71) when compared to the normal latches in the prior connectors as shown in FIG. 73. Another embodiment showing the angled latch arm option (FIG. 72) is also not as easy to press down when compared to the C-spring or reverse angle arm support as in FIG. 45. The C-spring based forward facing latch arm and dual-action T-piece embodiment allows this invention to be made from a single strip of material easily. As the preferred methods involve mounting the forward facing latch arms at the rear most ends of the plugs opposite to the contact side of the RJ type connectors, the forward facing latch arm can be made longer thus making it easier to press down to engage and disengage the dual-action T-piece and this also provides a better upward spring effect with less fatigue on the materials used as shown in some of the embodiments (FIGS. 1 to 4).

There are several embodiments of this new invention with a plurality of mounting methods and variations of the forward facing latching arms for the common dual-action T piece. This invention allows the prior-art RJ connector with the broken latch to regain its latching function hence ensuring reliable contact with the RJ socket's electrical contacts.

The invention will be easy to manufacture with simple equipment.

The various forward facing latch arm options, (the C-spring based ones in particular) and mounting solutions, allows for a fast and efficient resolution to enable the dual-action T-piece to anchor in the socket. There are two main categories of this invention these are: (a) the stick on variety, of which one embodiment can be deemed universal and (b) the clip/slide on ones with some variations described below to repair the RJ type connectors.

The new inventions forward facing latch arms (with some variations) all have the same dual-action T-piece in front with different options for the base mounts to produce several different embodiments with the same function to latch the RJ type connector to its socket. The function of the base mounts is to attach the forward facing latch arm (with variants) and the dual-action T-piece at a determined height and distance from the end of the mounting base and facilitates a means to introduce the forward facing latch arm and dual-action T-piece at the correct height causing upward tension when engaged with the socket to ensure that the narrow waist of the dual-action T-piece is securely locked between the locking lugs of the socket as shown in (FIGS. 81 and 82).

When in the latched position the frontal flanges (items 3 and 6) of the dual-action T-piece resist the reverse outward motion under normal use. The rear flanges (items 9 and 10) on the dual-action T-piece resists forward inward motion under normal use and thus facilitates the alignment of the invention where the installer pushes the RJ modular plug fully into the socket and adjusts the invention on this union until the locking lugs anchors in the optimum position to ensure a perfect fitment. This can be seen to happen as the narrow waist 5 will rest in the middle of the locking lugs (items 15 and 16) or ‘felt’ as when the forward facing latch arm is pushed in, once the frontal lobe (2) of the dual-action T-piece passes over the lugs it snaps onto the roof of the socket making a slight click and further forward movement of the latch arm is then impeded due to flanges 9 and 10. This is especially useful where the installer can align the embodiments like the stick/slide on options where fine adjustment is possible and desirable, particularly if the tolerance and/or reference marks on the prior connector are out of specification. Full details and diagrams will show this in further detail.

The base mounting options are not limited to the stick/slide/clip on, methods. The stick on embodiment entails the bottom of the C-spring to be adhered to the top section of the RJ type connector with the broken clip. The slide on base embodiment involves a box shaped mount with a slot at the bottom end opposite to where the latching arm is, as shown in FIG. 9. This base mount can be made with different dimensions for the different size of connectors. The slot at the bottom allows the prior RJ connectors cable to slide inside the box by virtue of this opening (slot) and the box base mount is then pushed over the rear of the connector with the forward facing latch arm facing the front of the plug in line with 24. This will be a tight friction fit due to the spring like action of the box shape, resisting being spread open.

The clip-on embodiment (FIG. 19) can be made from the same flexible strip as the latch arm with the bends described or made separately with different items. The clip-on base (FIG. 34) has a tight springy fit to enable it to clamp itself to the rear upper body of the RJ type connector on both the upper and inner sections of it. This acts as a body clamp when it is pushed onto the rear top end of the RJ modular plug. The dimensions of the forward facing latch arm in particular the length is adjusted for the different sizes of plugs. All the above embodiments can be made with flexible thin metal, plastic or other materials and can be molded, cut or stamped as required.

The RJ type connectors mentioned above encompass the range below and include others not necessarily on this list and will fit the majority of these examples: RJ9, RJ10, RJ11, RJ12, RJ13, RJ14, RJ15, RJ18, RJ22, RJ25, RJ31, RJ38, RJ41, RJ45, RJ48, RJ49, RJ50, RJ61.

The universal embodiment of the stick on invention will work on most of these connectors on the list that are similar to the RJ11 and RJ45 types of modular connector and can have some dimensions changed to fit the others that are not similar to the RJ11 and RJ45 type of modular connectors in terms of width of the forward facing latch arm and dual-action T piece.

### DRAWING

FIG. 1 shows a projection view of the stick on embodiment of the invention mounted on the RJ45 type plug/connector (18).

FIG. 2 shows the right hand side view of FIG. 1, also showing the optional stopper (26).

FIG. 3 shows the projection view of the stick on embodiment of the invention mounted on the smaller RJ11 type plug/connector.

FIG. 4 shows the right hand side view of FIG. 3, showing the optional stopper (26).

FIG. 5 shows the top view of the stick on invention as shown in FIGS. 1 and 3.

FIG. 6 shows the left hand profile view of the stick on invention.

FIG. 7 shows the rear end view of the stick on invention.

FIG. 8 shows the right hand profile of the stick on invention.

FIG. 9 shows the projection view of the slide on embodiment of the invention as fitted onto a typical RJ45 type connector.

FIG. 10 shows the left hand view of the slide on invention as shown in FIG. 9.

FIG. 11 shows the top view of the slide on invention as in FIG. 9.

FIG. 12 shows the right hand view of the slide on invention as in FIG. 9.

FIG. 13 shows the projection view of an embodiment of the slide on invention as made for the smaller RJ11 type connector, the top is similar to that in FIG. 9 and only the base 7A is replaced by base 7B.

FIG. 14 shows the rear view of FIG. 9 made for the RJ45 type connector.

FIG. 15 shows the rear view of FIG. 13 made for the RJ11 type connector.

FIG. 16 shows the right hand view of FIG. 13 fitted on the RJ11 type connector.

FIG. 17 shows the top view of the slide on invention in FIG. 13 made for the RJ11 type connector.

FIG. 18 shows the left hand side view of the FIG. 13.

FIG. 19 shows the projection view of the clip-on embodiment utilizing the C-spring as fitted onto a typical RJ type connector (in all the clip-on embodiments the forward facing latch arm is made longer for the RJ45 type connector invention).

FIG. 20 shows the top view of the clip-on invention in FIG. 19.

FIG. 21 shows the right hand profile view of FIG. 19 showing that the base can be made from the same strip of material as the complete forward facing latch arm.

FIG. 22 shows the left hand profile view of FIG. 19 showing that the base can be made from the same strip of material as the complete forward facing latch arm.

FIG. 23 shows the projection view of the clip-on invention as made for the smaller RJ11 type connector, made with thin material.

FIG. 24 shows the projection view of the clip-on invention as made for the larger RJ45 type connector, shown made using thicker material.

FIG. 25 shows the right hand profile view of FIG. 19 showing a standalone clip-on base consisting of items 7C, 8A and 17A for the RJ11 type connector and can be made with items 7C, 8 and 17 for the RJ45 type connector.

FIG. 26 shows the projection view of the embodiment of the clip-on non C-spring invention as fitted onto a typical RJ45 type connector.

FIG. 27 shows the projection view of the clip-on non C-spring invention as fitted onto a typical RJ11 type connector.

FIG. 28 shows the top view of the clip-on non C-spring invention as shown in FIG. 27.

FIG. 29 shows the right hand view of the clip-on non C-spring invention on all RJ type connectors.

FIG. 30 shows the left hand view of the clip-on non C-spring invention on all RJ type connectors.

FIG. 31 shows the projection view of the clip-on non C-spring invention with the clip-on base for the RJ11 type connectors. (The RJ45 type embodiment of this would be similar but with items 8 and 17 in the place of 8A and 17A).

FIG. 32 shows the projection view of the clip-on non C-spring invention with the clip-on base for the RJ45 type connector, without the vertical (11) or angled (12) link arms.

FIG. 33 shows the projection view of a typical stick on base mount profile.

FIG. 34 shows the projection view of a typical clip-on base mount profile.

FIG. 35 shows the projection view of a typical slotted box (slide on) base mount profile.

FIG. 36 shows the projection view of the present invention with the C spring, the forward facing latch arm and the dual-action T piece. The distal end of the forward facing latch arm can connect directly to any of the base mount options in FIGS. 33-35.

FIG. 37 shows a projection view of an embodiment consisting of a forward facing latch arm, a dual-action T piece, and the C spring, which has been replaced by a vertical link arm (11). The distal end of the forward facing latch arm can connect directly to any of the base mount options in FIGS. 33-35.

FIG. 38 shows a projection view of an embodiment consisting of a forward-facing latch arm, a dual-action T-piece and the C-spring has been replaced by angled link arm (12). The distal end of the forward facing latch arm can connect directly to any of the base mount options in FIGS. 33-35.

FIG. 39 shows a projection view of an embodiment consisting of a forward facing latch arm, a dual-action T-piece without a C-spring and the distal end of the forward facing latch arm can connect directly to any of the base mount options in FIGS. 33-35.

FIG. 40 shows the projection view of the present invention with the C spring, the forward facing latch arm and the dual-action T piece.

FIG. 41 shows the projection view of FIG. 40 with a wider base mount similar to that in FIG. 33.

FIG. 42 shows the projection view of FIG. 40 with a clip-on base mount as shown in FIG. 34.

FIG. 43 shows the projection view of FIG. 40 with a slotted box (slide on) base mount as shown in FIG. 35.

FIG. 44 shows a typical profile view of the embodiment in FIG. 37 mounted on a slide on slotted box base as in FIG. 35 when fitted on a RJ connector that is inserted into a socket.

FIG. 45 shows a typical profile view of the embodiment in FIG. 38 mounted on a slide on slotted box base as in FIG. 35 when fitted on a RJ connector that is inserted into a socket.

FIG. 46 shows a typical profile view of the embodiment in FIG. 39 mounted on a slide on slotted box base as in FIG. 35 when fitted on a RJ connector that is inserted into a socket.

FIG. 47 shows an example of how a single strip of material can be used to make the stick on or clip-on embodiments. The two vertical parallel lines show where the strip can be bent to make the C-spring (20).

FIG. 48 shows a projection view of the forward facing latch arm and C-spring when the in FIG. 47 is folded at 20.

FIG. 49 shows an example of how the strip of material in FIG. 47 can be machined (to make items 8A and 17A) to create the clip-on embodiment in FIG. 50 for the RJ11 type connector. To make a clip-on embodiment for the RJ45 type connector narrowing the end of the strip of material is not required.

FIG. 50 shows a projection view of the forward facing latch arm and C-spring with a clip-on base (made for a RJ11 type connector).

FIG. 51 shows FIG. 47 with a wider base section that can be stuck on or made from a wider strip of material and the forward facing latch arm cut out from it (outlined by the thin lines).

FIG. 52 shows a projection view of FIG. 51 folded to make the stick on base embodiment with a wider base.

FIG. 53 shows the top view profile of how the dual-action T-piece can be manufactured by cutting along the dotted lines and then folding the resulting flanges if made from a thin strip of material.

FIG. 54 shows the right hand side view of the dual-action T-piece as shown in FIG. 53.

FIG. 55 shows the right hand side view of how the dual-action T-piece looks when made from thicker material, folding of flanges is not required.

FIG. 56 shows how the slide on embodiment can be made using a strip of material with the dual-action T-piece and the forward facing latch arm cut out as well as the larger flaT-piece of material which is then folded along the dotted lines shown on items 7A/7B in this diagram to make a open ended slotted box section as in FIG. 57.

FIG. 57 shows the rear view of the embodiment in FIG. 56 when it's been folded to make the slide on slotted box base 7A/7B and the C-spring when folded at 20.

FIG. 60 shows a projection view of a prior RJ45 type connector.

FIG. 61 shows a projection view of a prior RJ11 type connector.

FIG. 62 shows a side view of a prior RJ45 connector.

FIG. 63 shows a side view of a prior RJ11 connector.

FIG. 64 shows a side view of a ‘broken latch’ on a prior RJ45 connector.

FIG. 65 shows a side view of a ‘broken latch’ on a prior RJ11 connector.

FIG. 66 shows the right hand side view of the invention with a clip-on mount, a dual-action T-piece with a C-spring forward facing latch arm.

FIG. 67 shows the left hand side view of the invention with a clip-on mount, a dual-action T-piece with a C-spring forward facing latch arm shown fitted on a RJ type connector.

FIG. 68 shows the right hand side view of the invention with a clip-on mount, a dual-action T-piece with an angled forward facing latch arm.

FIG. 69 shows the left hand side view of the invention with a clip-on mount, a dual-action T-piece with an angled forward facing latch arm shown fitted on a RJ type connector.

FIG. 70 shows that the forces at the top of the dual-action T-piece and the front of the base mount will be almost equal and opposite when used with the C-spring in particular.

FIG. 71 shows the ease in being able to press down the C-spring forward facing latch arm of the present invention.

FIG. 72 shows how the non C-spring forward facing latch arm can be more challenging to press down, even though the forward facing latch arm is attached at the rear most point of the RJ type connector.

FIG. 73 shows the press down points of the prior RJ type connector.

FIG. 74 shows the right hand side view of how a typical dual-action T-piece and a forward facing latch arm can look like when made from thicker material.

FIG. 75 shows the right hand side view of how a typical dual-action T-piece and a forward facing latch arm can look like when made from thin metal or other thin material; the flanges are there to ensure there are no sharp edges.

FIG. 76 shows the bottom view of a typical dual-action T-piece using thick material, no bent flanges are required and the sections 2 and 4 can be rounded and angled off to facilitate easier access into the socket.

FIG. 77 shows the bottom view of a typical dual-action T-piece using thin material i.e. springy metal or other thin springy material. The flanges make these items 3, 4, 6, 9 and 10.

FIG. 78 shows how a prior RJ type connector's rear latch arm gets caught easily in the wire loom or other objects when the wire is pulled in the direction of the arrow to separate or disconnect it.

FIG. 79 shows how one embodiment of the present invention's forward facing latch arm allows the cable to slide over it when the wire is pulled in the direction of the arrow shown to separate it or remove it from a congested wire network harness etc. It does not act as a hook.

FIG. 80 shows the front profile view of a typical RJ type socket showing the locking lugs items 15 and 16.

FIG. 81 shows a projection view of how the dual-action T-piece and the forward facing latch arm engage with the locking lugs (items 15 and 16) in the RJ type sockets.

FIG. 82 shows the top sectional view of the locking lugs (items 15 and 16) on the socket being entrapped between the narrow section of the dual-action T piece.

### DESCRIPTION OF THE INVENTION

Possible preferred embodiments will now be described with reference to the drawings and those skilled in the art will understand that alternative configurations and combinations of components may be substituted without subtracting from the invention. Also, in some figures certain components are omitted to more clearly illustrate the invention.

In the several embodiments of this invention it should be understood that and references will be made items, elements, components and other aspects of the invention and these may or may not be fully illustrated in a particular figure of the drawing. Further, is should be understood that a given embodiment will have or may have some similar features with other embodiments where they all perform similar functions and share some similar aspects.

Existing and typical RJ-type connectors allow for the quick connection and disconnection of data/voice or similar cable or lines to a device: Part of this ease comes from the use of a rearward facing latch arm that extends upwardly and outwardly from the connector body, away from the socket of the device in which the connector plugs. To ensure proper data and electrical signal communication, it is important for the connector to make a solid connection with the device. However, to facilitate ease-of-use, replacement, repair, or simply temporary use of a cable to a device (for example, the mobile worker that connects his laptop to a port provided by a hotel), such data cables include the RJ-type connector that includes a rearward facing latch arm that snaps into place when the connector is mated to the device—thus securing the data/electrical connection—and, for removal, the latch is designed to be easily manipulated by the user to release the connector from the device. Unfortunately, from use or misuse, this latch fails—typically, it breaks off.

Accordingly, the present invention contemplates a device and system that can be used to retrofit damaged RJ-type connectors. Further, the present invention maintains the usability of the existing (albeit damaged connector) by repairing it in such a manner that the user can easily connect the connector and cable to a desired device and disconnect it as if the RJ-type connector was never damaged in the first place. Further, the present invention includes a forward-facing connector latch arm that—in contrast to the prior art latch arm that faces inward and upward (rearward facing)—cannot become entangled or caught on the excess cable or other items: this makes the present invention far more robust and prevents incidental or accidental damage to the latch arm.

The present invention, in it various preferred embodiments, recognizes that the prime operation of the latch arm on an RJ-type connector is to place an upward force against the device when inserted therein. Accordingly, the present invention includes a forward facing latch arm that applies an upward force on the front locking section of the forward facing latch arm so that it effectively locks the narrow waist section of the dual-action T-piece in between the locking lugs provided by the RJ-type connector plug.

Under normal use, to disengage the latch arm, and hence remove the plug/connector, the forward facing latch arm is depressed down so as to allow the locking section of the forward facing latch arm/dual-action T-piece to go below the locking lugs provided by the RJ-type connector. These lugs protrude from the internal ceiling of the modular socket. This allows the front of the dual-action T-piece to have the lateral clearance to be pulled out of the socket with no hindrance from the locking lugs (items 15 and 16) in the socket.

The invention and its various embodiments include a forward facing latch arm extending from the rear or the mounting option on the of the top surface of the RJ-type connector close to the front top section of the modular RJ type connector thus presenting the dual-action T-piece towards the front contact side of the RJ-type connector. The dual-action T-piece is manufactured to ensure that the complete invention locks the RJ-type connector securely in the correct location in the socket to acquire the best electromechanical contact with the socket and its contacts.

Another embodiment has the same forward facing latching arm and dual-action T-piece but the mounting base is replaced by an open slotted box mount which runs parallel to the latching arm of the slide on embodiment. This allows the communication cable to be encompassed by the box section base by passing the cable through the opening/slot in the box section and the box section is then pushed over the distal end of the plug with the forward facing latch arm pushed into the front of the socket so that the front end of the dual-action T-piece is in front of the locking lugs and the distal end of the dual-action T-piece is at the back of the locking lugs. This ensures an accurate fix and even allows for installation whilst the existing connector is still in the socket and does not need to disrupt any communications.

This in-situ installation also means that the stick on, slide on or clip-on versions can be fitted fast and accurately and lets the adhesive bond better where removing and refitting the stick on embodiment will be kept to a minimum to get the installation right due to the flanges of the dual-action T-piece which allow the lugs (items 15 and 16) to be entrapped between the forward and rear flanges at the optimum position.

In one embodiment the based stick on invention provides a complete solution for replacing the broken locking latch arm in the RJ-series of connectors be it the smaller (RJ11 type) or larger versions (RJ45 type) of modular connector types. This embodiment could be deemed universal as the same invention will fit most of the many sizes of RJ-type or similar connectors mentioned above with no change in dimensions or form.

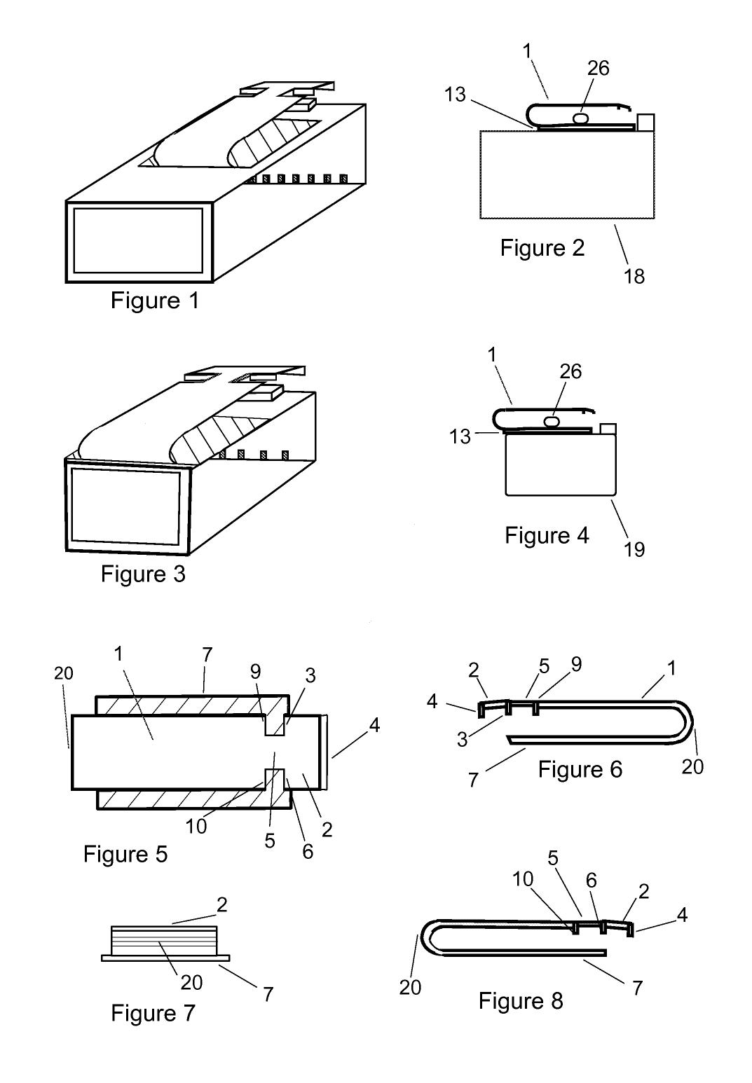

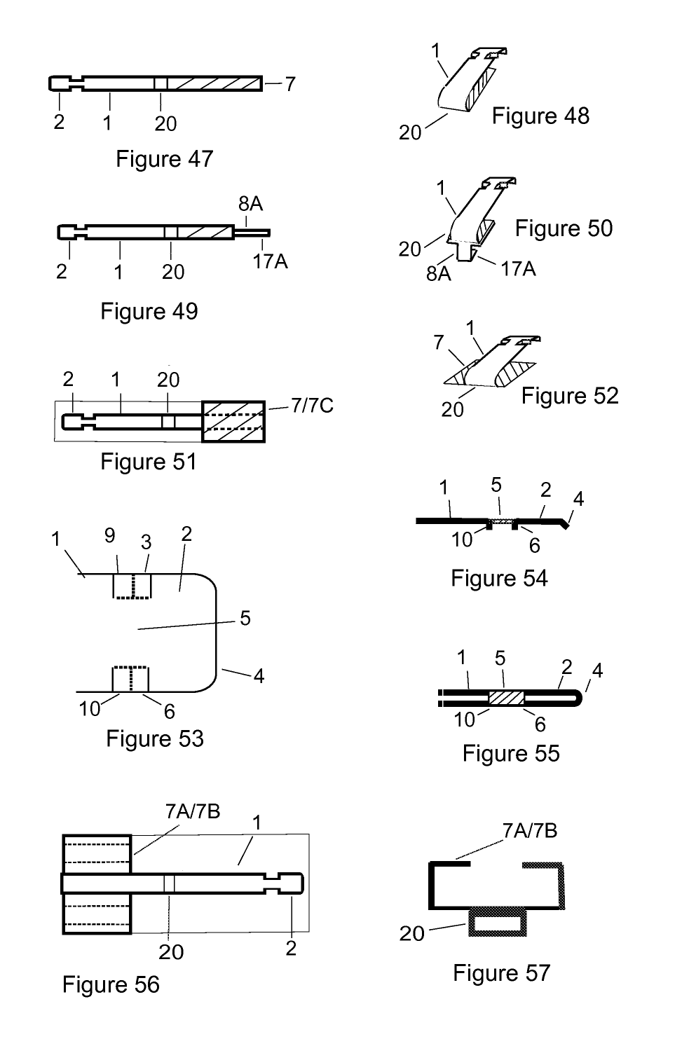

In the first embodiment the mounting of the inventions lower base arm's surface to the top of the RJ-modular plug as shown in FIG. 1 as fitted on a RJ45 type connector can be adhesive based. This adhesive can be fast setting glue or double-sided sticky tape. FIG. 3 shows the same invention in form and dimension to that installed in FIG. 1 mounted on a RJ11 type connector. The base mount in this embodiment can be made from the same strip that the upper forward facing latch arm and dual-action T-piece are made as shown in FIGS. 47 and 48 or with a wider base that will fully fit the width of the RJ11 type connector and partially fit the width of the RJ45 type connector as shown as in FIGS. 51 and 52 as well as FIGS. 1 and 3.

This embodiment with the wider base plate increases the surface contact area between the bottom of the latching arms C-spring base and the surface of the connector and can assist in visually aligning with the reference molding mark 14 or the rear of the connector or its sides. This embodiment is easy to align with minimal skills to adhere to the top surface of the RJ type modular connector and engage the locking mechanism to function as designed to do so. This ensures that the electrical contact is restored as desired. In all the embodiments mentioned here the dual-action T-piece is a common part and it has a narrow waist 5 in the front node of the forward facing latch arm. The frontal flanges items 3 and 6 in the dual-action T-piece anchor the forward facing latch arm in the sockets upper internal housing's locking lugs when aligned correctly, under upward pressure which is provided by the C-spring (where used) and the length of the forward facing latch arm's own spring like action due to the virtue of the material used and the length when under load or downward pressure as occurs when the forward facing latch arm is pressed down when pushed into the socket and held under pressure induced by the internal ceiling of the socket. The rear flanges, items 9 and 10 of the dual-action T-piece act as end stops and hence when the stick on and slide on embodiments are first installed and aligned, these distal end flanges stop the front end of the forward facing latch arm and dual-action T-piece from going too far into the socket and hence allows for a helps quick fast fit and reduces the number of attempts required to align this and enables the adhesive to take hold better.

In the slide on mounting embodiment this ensures that the mount is not continuously adjusted forward and backwards on the RJ type connectors if the form of the RJ type connector is not in tolerance or the reference marks are not in the standard locations to get an acceptable fit thus avoiding the box shaped mount from getting loose and this maintains a tight friction fit and allows for ‘fine tuning’.

In the embodiments using the adhesive base (stick on) or slide on base, the dual-action T piece's double locking feature compensates for different lengths and tolerances in the various RJ type connectors housings. Once the slide on mount is aligned accurately within the narrow waist encompassing the locking lugs (items 15 and 16) the plug is at its optimum contact position in the socket. A drop of adhesive glue can be introduced between the mounting base and the RJ plug in such a way it does not get on the contacts or bond with the socket and is best added when the RJ type modular plug and the newly attached and aligned invention. As always take necessary protection when using adhesives. Those in the art of using and making similar embodiments will appreciate that the adhesive is not essential as the spring clamping effect of the slide on base (items 7A and 7B) will provide a good secure attachment and replacement will be much easier in the future with no adhesive. The C-spring base embodiments and dual-action T-piece and horizontal forward facing latch arm can be used with all the mounts shown in FIGS. 33, 34 and 35 as well as others not described here to make various embodiments of this invention being the stick on, clip-on or slide on mounts.

There is another embodiment where there is a straight-arm 11 at the rear of the RJ type connector linking the base mounting options to the upper forward facing latch arm and dual-action T piece, which is shown in FIGS. 37 and 44.

Another embodiment the C-spring consists of a rear angled linking arm (items 38 and 45) that attaches the mounting base to the forward facing latch arm and dual-action T piece. These act in a similar manner where the forward facing latch arm's upper section can be mounted further back from the front end of the RJ type connector. This allows for a bigger surface area and length on which the forward facing latch arm can be pressed down on, to disengage the plug from the socket.

These embodiments can also use the mounting methods shown in FIGS. 33, 34 and 35. This makes the invention more practical as the shorter or poorly angled forward facing latch arms (e.g. FIG. 46) are difficult to press especially when installed behind equipment were visibility is poor and feeling for the connector is the only option and persons with limited manual dexterity will find it hard to press down. This is not an issue with the longer more horizontal forward facing latch arms.

Those skilled in the art of manufacture will be able to make any of the embodiments with any of the various mounts/bases and angles easily and can use one single strip especially in the case of springy metallic material. If plastic strips or molded plastic is used to make the invention in all cases the material used must be flexible where required and of high durability to resist fatigue easily. Making this invention in metal ensures longevity and fine adjustments and tightening of the bases is easier and reduces chances of the new invention breaking as easily.

The C-spring based design of this invention as shown in FIGS. 1, 3, 9, 13, and 19, for example, are a few of many examples showing the most versatile (preferred) of all the embodiments is the C-spring and forward facing latch arm variants. In these variants (alternate preferred embodiments), the spring effect will last a lot longer than the prior-art anchor points or links made with sharper bends as these prior-art-taught sharper bends become the weak points 24.

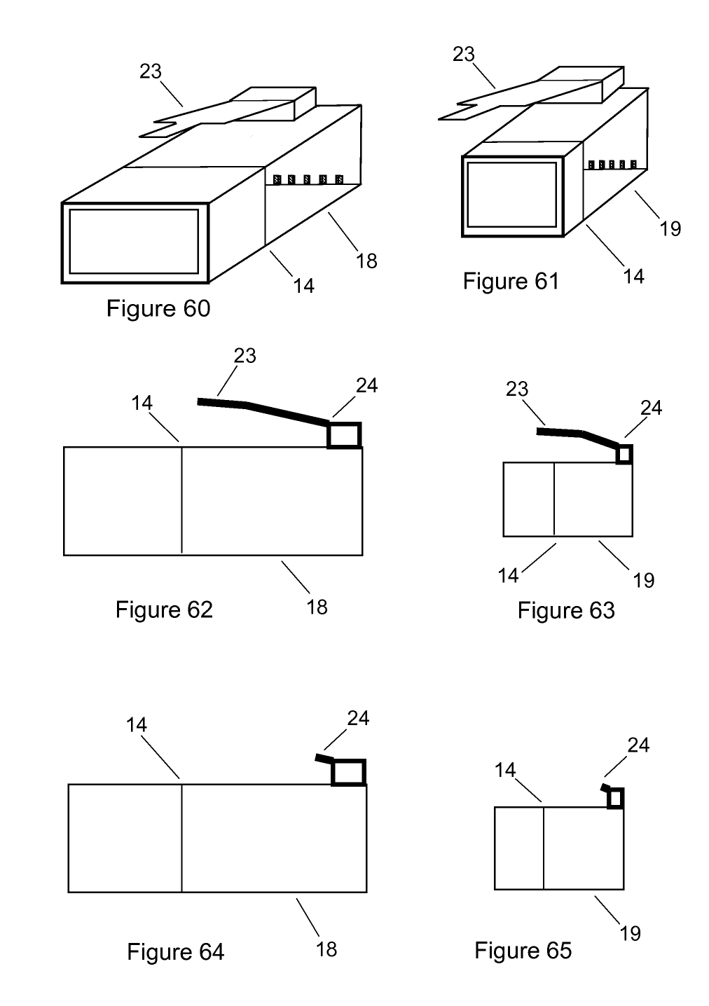

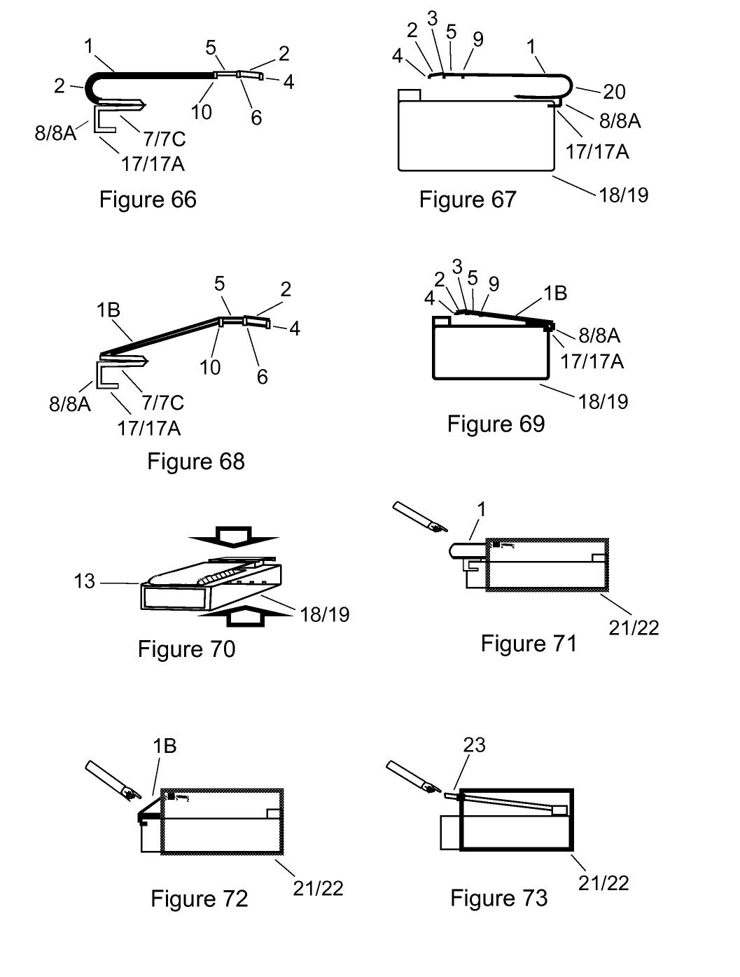

Further description of the preferred embodiments is made with the aid of the figures and diagrams of the drawing, which show the various embodiments and their individual contributions to this invention. FIGS. 60-63 show the prior latch arm assembly on RJ11 and RJ45 connectors at present with the weak point labeled 24, where the prior latch arm joins its connecting block at the front end of the plug.

FIGS. 64 and 65 show the weak point 24 at which the prior-art latch arm breaks on the RJ11 and RJ45 connector: Being plastic this narrowed section easily breaks due to wear and tear or snagging with other leads as shown in FIG. 78 where the reverse facing latch arm in the present RJ type connector breaks when it gets caught in other cables or objects when the cable is pulled in the direction of the arrow where the user pulls the cable to pull the connecter from a cable harness or when unpacking it from a coil. To reduce failure related to fatigue or from anticipated damage, the present invention is preferably made from metals, plastics, or carbon fiber based materials.

FIG. 79 shows an example of the C-spring embodiment and shows how the forward facing latch arm does not get trapped in other objects or cables when pulled in the direction of the arrow. The cable slides over the top of the forward facing latch arm and this is not the case with the prior-art latch arm (for example, as shown in FIG. 78) where the prior-art latch arm acts as a hook.

FIG. 70 shows, with arrows, the typical forces on the top of the forward facing latch arm. Due to the nature of the C-spring shaped connecting arm, the upper and lower forces almost cancel each other out at the front end of the new invention's dual-action T-piece and the lower front base mount hence there is no leverage effect to raise the rear of the new invention as would be the case if the forward facing latch arm was closer to the front of the base mounting plate (as in FIG. 46). This is useful where the mounting option is the stick on method.

FIG. 71 shows the benefit of the C-spring in this invention over the rear angled link ‘supports’ as shown in FIG. 72. FIG. 73 shows the present latch arm and how it is pressed down to release the latch.

FIG. 80 shows the typical outline of the locking lugs (items 15 and 16) on the RJ type sockets where there are two raised lugs on either end of the top most recess of the connector where the forward facing latch arm enters through to position the dual-action T-piece in its desired location to anchor in.

FIG. 81 shows a projection view of how the invention's forward facing latching arm rests in its latch position with the narrow waist (5) is in between the locking lugs items 15 and 16. The locking lugs are surrounded by the four flange/contact areas (items 3, 6, 9 and 10) of the dual-action T piece. This upward action of the forward facing latch arm ensures that the lugs stop the plug from sliding out unless excessive force is used to pull it or when the forward facing latch arm is depressed down to allow the front of the dual-action T-piece and the forward flanges to go below the locking lugs prior to pulling the plug out.

FIG. 82 shows the sectional top view of how the dual-action T-piece is locked between the lugs (items 15 and 16) by virtue of the narrow waist 5 fitting into the void, where the front of the dual-action T-piece and the remainder of the forward facing latch arm cannot fit into due to being wider. This aids in the fine alignment of the stick on or slide on embodiments where the process of alignment is made easier. The alignment involves making sure the connector is at the optimum position in the socket and then the new invention is presented to the assembly with the forward facing latch arm where the front end or the dual-action T-piece is pushed inwards until a click is heard or felt and the narrow waist 5 can be seen between the lugs 15 and 16. The distal end of the dual-action T-piece flanges (items 9 and 10) will then stop the latch arm going in any further ensuring there is no misalignment or play due to the arm going too far into the connector. Once this lock is attained the invention can be stuck down and the downward pressure induced by the C-spring will ensure the adhesive takes hold on the stick on embodiments especially.

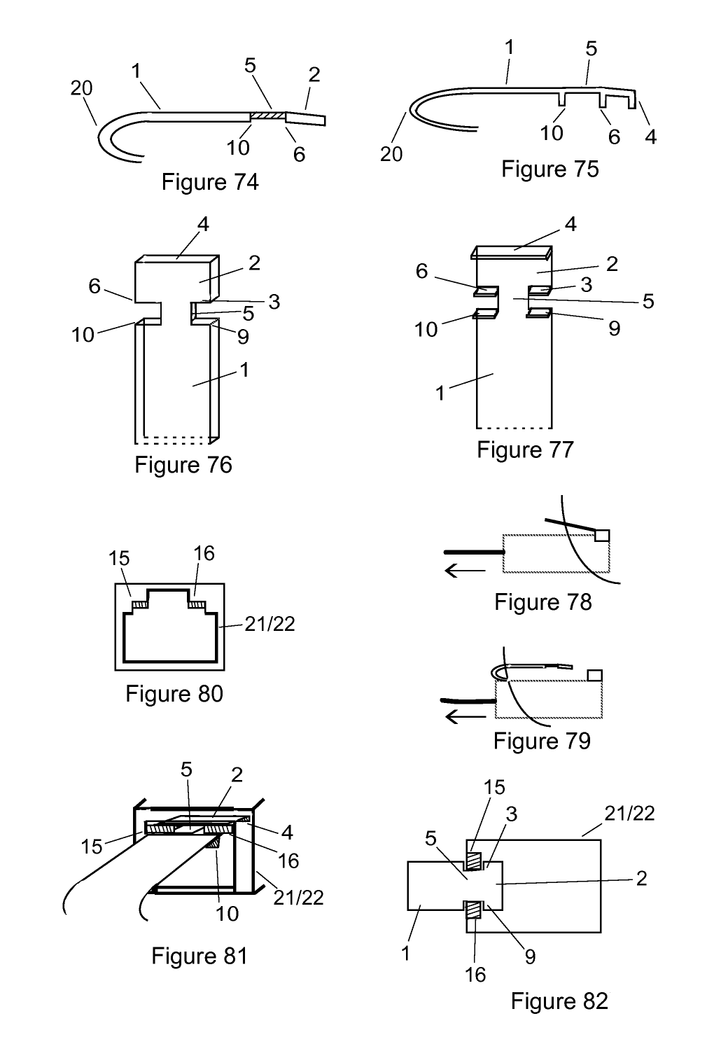

FIG. 74 shows the side view depicting how the C-spring and dual-action T-piece can look in an embodiment where the invention is made from plastic or other thick flexible material and FIG. 76 shows how the front end of the invention in FIG. 74 can look from underneath to show the typical construction of the flange/contact areas of the dual-action T-piece in particular the items 4, 3, 6, 9, and 10. The frontal area items 2 and 4 can be angled downwards to facilitate easier entry to the socket. All sharp contact points will be slightly rounded to ensure no damage occurs to the locking lugs.

FIG. 75 shows the side view of an embodiment of the dual-action T-piece and C-spring forward facing latch arm made from thin materials for example flexible metal.

FIG. 77 shows the flanges 4 and 3, 6, 9, and 10 at the main contact areas if made from thin material. The bent flanges are desirable due to the sockets lugs, items 15 and 16 and other socket components being made from plastic and with regular insertion of thin, hard and other sharp materials would wear away or damage the locking lugs items 15 and 16 rapidly. Those in the art of manufacture can use this method to ensure that the socket will not be damaged and ensure that all sharp edges in any embodiment and materials used in the dual-action T-piece are rounded.

The front flange 4 is angled to ensure easy entry to the socket with minimal damage, wear and tear to both bodies. The size of the flanges can be made to any size suitable to cause minimal damage to the locking lugs.

FIG. 1 shows the projection view of a universal fit stick on forward facing latch arm invention as fitted to a RJ45 type connector. Whilst this is shown with a wide mounting base for diagrammatic purposes here, it can be the same width as the top section of the forward facing latch arm as shown in FIG. 48. This exact embodiment in dimension and form can be used on the smaller RJ11 types as well as shown in FIGS. 2 and 4. FIG. 5 shows how the top view can be of the embodiment in FIG. 1. FIGS. 6 and 8 show the side view of this.

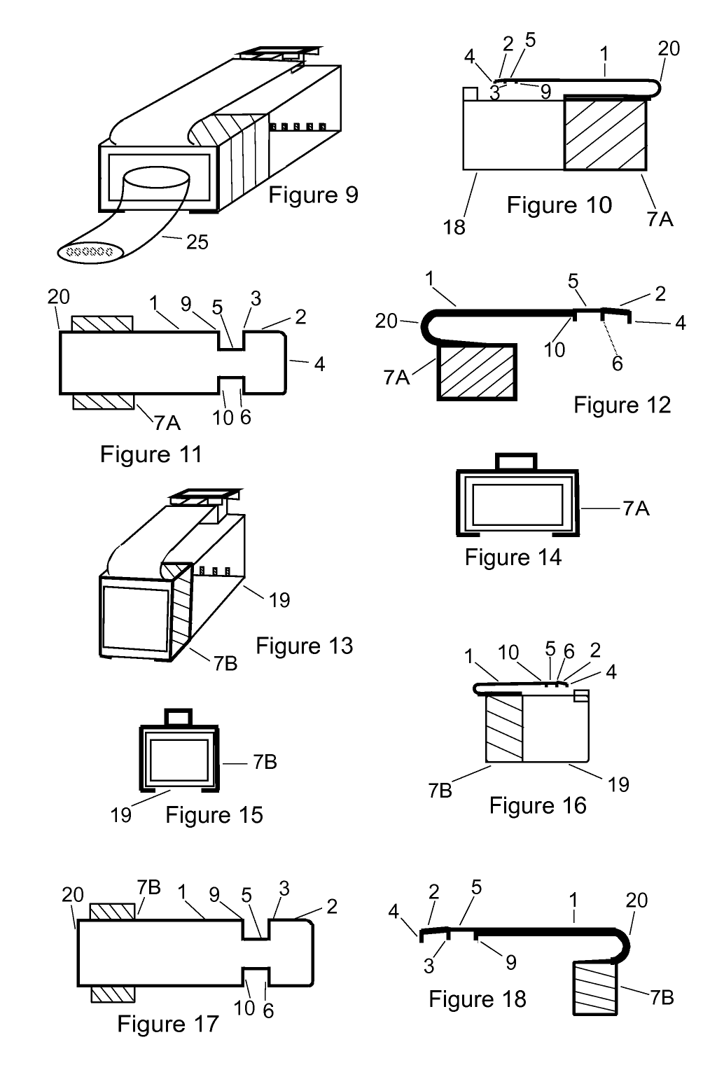

FIG. 9 shows the projection view of an embodiment of the invention using a slotted box base as fitted on a RJ45 type connector. The slot at the bottom of the box shaped mount is there to allow the cable/lead of the present broken latch connector to be inserted into the slot to ensure that the forward facing latch arm can then be located in the correct position and then sliding this box section (7A for the RJ45 and 7B for the RJ11 type connectors) over the distal end of the said connector with the forward facing latch arm being on the same side that the original latch arm was on the connector. In these two embodiments there are different dimension for the box sections 7A and 7B and also for the forward facing latch arm 1 but the dual-action T-piece will be identical.

The box mount (slide on) embodiment in FIGS. 9 and 13 can be made several ways one being made from one thin strip as in FIG. 47 to make the C-spring section and then attaching the box section (7A or 7B). It can also be made of a wider strip of material as wide as the box section 7A or 7B prior to its folding and the narrow forward facing latch arm (1 and dual-action T piece) section is cut/stamped out as in FIG. 56. Then the box is folded as per the lines in the box section (7A or 7B) as shown in FIG. 56, to make the slotted box shown in FIG. 57.

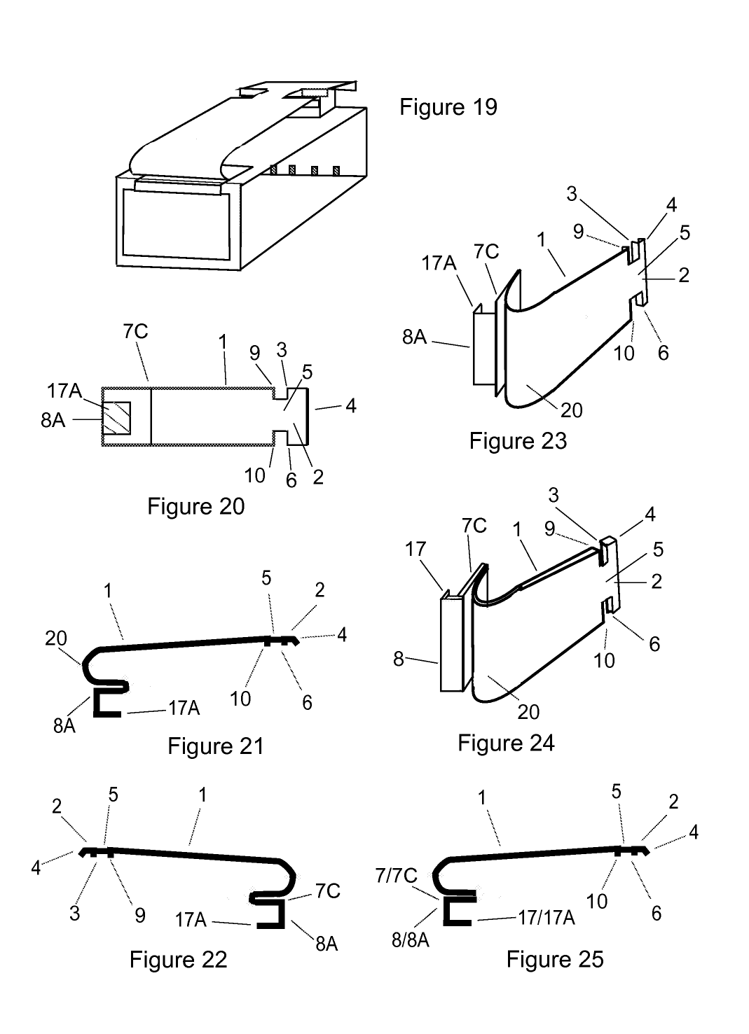

FIG. 19 shows a projection view of an embodiment that uses the forward facing latch arm, the C spring, and the dual-action T-piece—but utilizes a different method to mount it to the surface of the RJ type connector. This is the clip-on base mount embodiment and this can be made from the same strip as the forward facing latch arm and for the smaller RJ type connectors the last few bends of the strip are made a bit narrower (as shown in FIGS. 49 and 50) to fit into the narrow opening in the rear cable end of the socket as shown.

FIG. 34 shows a standard clip-on mount that can be used on all the embodiments utilizing the forward facing latch arm and FIG. 42 shows this clip-on version in one of many embodiments possible.

FIGS. 20-25 show the various views of FIG. 19. FIG. 23 shows the projection view of the embodiment in FIG. 19 with the clip-on base comprising of items 7C, 8A and 17A, which are slightly shorter in length then items 8 and 17 to ensure that the clip-on base fits in the smaller recess of the rear of the RJ11 type connector and the flanges if made with thin material.

FIG. 24 shows the embodiment in FIG. 19 made for a RJ45 type connector and is shown made from thicker material.

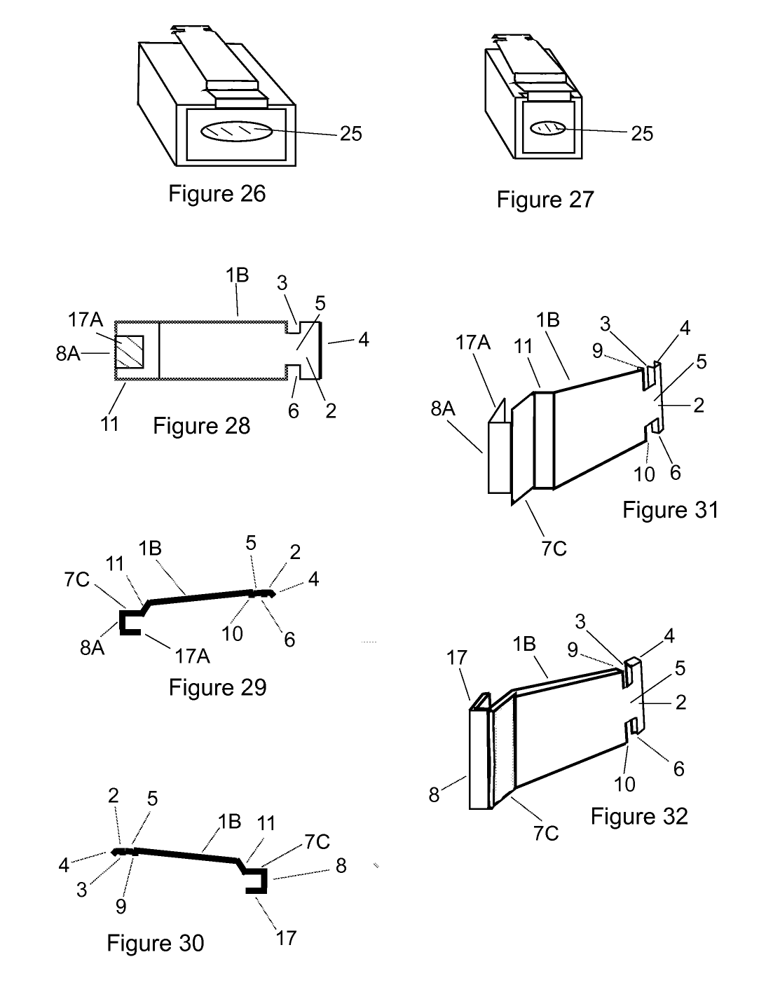

FIG. 26 shows an embodiment of the non C-spring forward facing latch arm and dual-action T-piece latch as fitted on a RJ45 type connector and FIG. 27 shows the same style embodiment fitted on a RJ11 type connector. In these embodiments the forward facing latch arm is made slightly longer for the larger RJ45 type connectors and the clip-on mounting base's bends items 8 and 17 are made narrower as per items 8A and 17A for the RJ11 type connectors, but the dual-action T-piece remains the same.

FIGS. 28 to 30 show different views of the embodiment in FIG. 27.

FIG. 26 will have similar profile views, but with some changes in dimensions only.

FIG. 32 shows another embodiment of FIGS. 26 and 27 where the vertical connecting link 11 is removed and the upper forward facing latch arm is angled downwards at its distal end to be joined on the short upper base 7C of the clip-on base.

The dual-action T-piece is designed to perform various functions, one of which stops the plug from sliding out of the socket, another function is to stop the forward facing latch arm going in too deep into the recess of the socket. This aspect of the invention can be made from the same strip as the forward facing latch arm and FIG. 53 shows a close up view of how the dual-action T-piece can be made using a thin sheet of material. This close up with the aid of dotted lines shows where cuts are made and the flanges 3, 6, 9 and 10 are folded at these lines marked. The folds can be perpendicular to the upper forward facing latch arm surface. The dual-action T-piece is always at the front end of the invention's forward facing latch arm at the end opposite to the base mount that is adjacent to the cable entry point of the RJ type connector.

FIGS. 47, 49, 51 and 56 show the strips before they are bent or molded to create the C-spring by bending or forming the materials along the two vertical lines around 20 to make the two ends of the strip parallel and opposite to each other.

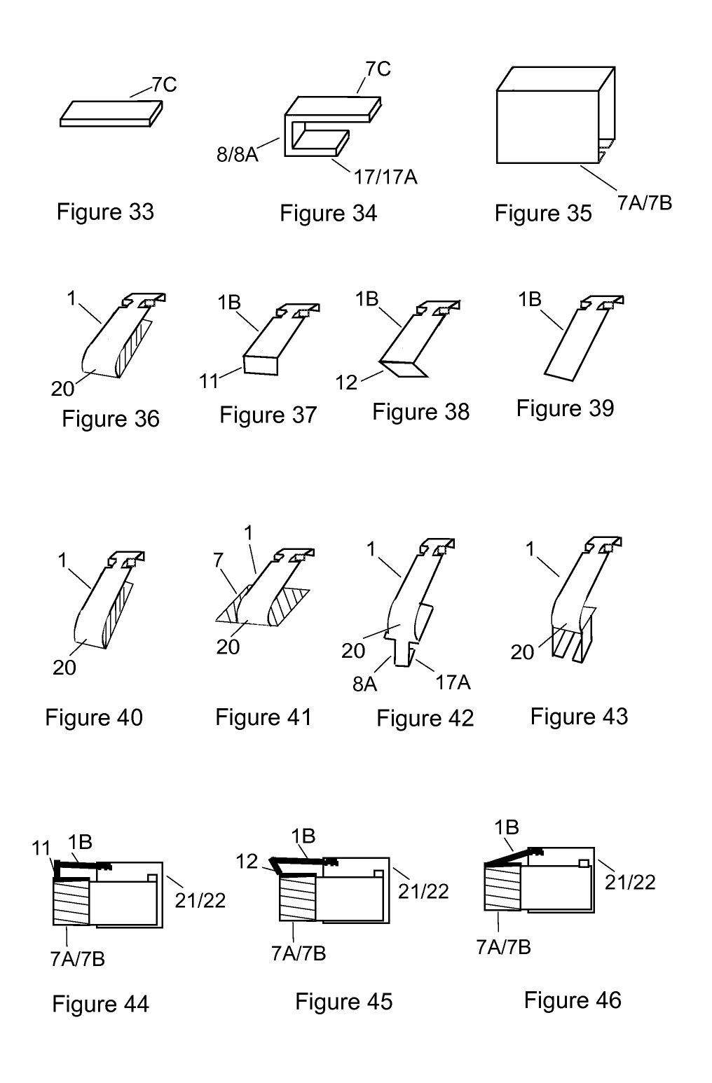

FIGS. 33 to 35 show the different base mounting options that can be used to make these embodiments; these provide alternative ways to mount the various embodiments of the forward facing latch arms and dual-action T-piece as shown in FIGS. 36 to 39. FIGS. 40 to 43 show how one embodiment of the C-spring forward facing latch arm (FIG. 36) can be formed to make some embodiments, however many more variations are possible.

FIG. 44 shows one embodiment of the invention where the C-spring further comprises a section having a short vertical link arm (11) that raises the distal end of the forward facing latch arm above the base. This allows the forward facing latch arm to be raised above the base and functions in a similar manner to the other embodiments of the latch arm but without the resilience and benefits of the curved C spring.

FIG. 45 shows another embodiment of the invention where the C-spring section consists of a short reversed angle link arm 12 that raises the distal end of the forward facing latch arm above the base but being angled away from the dual-action T piece. This allows the forward facing latch arm to be raised above the base and functions in a similar manner to the other embodiments of the forward facing latch arm but without the resilience and benefits of the curved C-spring but allows this embodiment to have a longer forward facing latch arm and this makes it easier to press down the forward facing latch arm in a similar way to the C-spring based forward facing latch arms. This is not the case if the embodiment shown in FIGS. 39 and 46 is used because the shorter angled arm is more difficult to press down.

FIGS. 44 to 46 are shown with the box shaped mount as in FIG. 35 but can also be used with the mounting methods in FIGS. 33 and 34. FIGS. 2 and 4 show an optional 26. This acts as a downward limiter and thus stops the forward facing latch arm from being pressed too far down so as to cause undue stress on the invention when it may be then pressed too hard against the top of the RJ type connector. This is made so as to allow the dual-action T-piece to go below the lugs but not too far down contact the top of the RJ type connector it is mounted on. This 26 can be used on all the embodiments described here.

In one particular preferred embodiment, the present invention contemplates a system for repairing an RJ-type connector. Those skilled in the art will understand that existing, common, and typical RJ-type connectors (and other similar connectors) have locking lugs adapted to engage a mating feature provided by a standard socket into which the connector is designed to interface with to provide quick but secure means for coupling and decoupling the connector to the socket to provide electromechanical connection. This preferred embodiment is well-suited to repair such a connector that has a broken, standard, rearward facing latch arm. This preferred system includes a forward-facing connector latch arm replacement device comprising a dual action T-piece comprising a T shaped distal end having a narrow waist section linking to the proximal end, and a C-spring coupled to the proximal end whereby the C-spring enables selective deflection of the T-piece whereby the narrow waist selectively engages and disengages the locking lugs provided by the RJ-type connector plug, the C-spring further comprising a base configured offset from and opposite to the distal end; and a means for coupling the connector latch replacement device to the RJ-type connector, the means comprises the C-spring resiliently pushing on the RJ-type connector.

This system further includes means for coupling the forward facing connector latch replacement device wherein an adhesive strip is disposed on an underside of the base of the C spring, whereby the adhesive strip selectively configures to adhere to the RJ-type connector.

Further, this system contemplates alternative means for coupling the forward facing connector latch replacement device consisting of a box coupled to the base of the C spring, the box further comprising a slot at the bottom to facilitate mounting the box over the cable and around the RJ-type connector.

Alternatively, this system includes means for coupling the forward facing connector latch replacement device further comprising a box shaped mount coupled to the base (see, e.g., FIG. 46) whereby the box shaped mount acts as a downward limiter and thus stops the forward facing latch arm from being pressed too far down and to allow the dual-action T-piece to go below the lugs but not too far down contact the top of the RJ type connector.

The C-spring, in one embodiment of this preferred system, further comprises a curved leading end coupled to the proximal end of the T-piece.

Alternatively, the system includes a C-spring further comprising a clip-on mount coupled to the base (see, e.g., FIG. 42 and FIG. 24).

Yet another alternative includes a C-spring comprising a bent leading edge coupled to the proximal end of the T-piece (See, e.g. FIG. 31).

Or, this system includes a C-spring further comprising (see, e.g., FIG. 44) a section having a short vertical link arm coupled to the proximal end of the T-piece, the section configured to raise the distal end of the forward facing latch arm above the base.

Yet again, this system includes a C-spring further comprising (see, e.g., FIG. 45) a short reversed angle link arm coupled to the proximal end of the T-piece whereby the short reversed angle link arm raises the distal end of the forward facing latch arm above the base and enabling a longer forward facing latch arm that is easier to press down upon.

The present invention in another preferred embodiment contemplates a method for repairing an RJ-type connector that is in situ, that is to say the connector is already coupled to a cable and the cable may already be at a location such as an office or may be on the benchtop of a work bench at a repair facility. Nevertheless, the RJ-type connector has a failed or broken standard rear-ward facing latch arm. This repair method includes providing a forward-facing connector latch arm replacement device comprising a dual-action T-piece comprising a T shaped distal end having a narrow waist section linking to the proximal end, and a C-spring coupled to the proximal end whereby the C-spring enables selective deflection of the T-piece whereby the narrow waist selectively engages and disengages the locking lugs provided by the RJ-type connector plug, the C-spring further comprising a base configured offset from and opposite to the distal end and a means for coupling the connector latch replacement device to the RJ-type connector, the means comprises the C-spring resiliently pushing on the RJ-type connector; and connecting the forward-facing connector latch to the RJ-connector.

This method may also include providing the forward-facing connector latch arm replacement device with an adhesive coupled to the base; and adhering the base to the RJ-type connector.

Another step of the method includes providing the forward-facing connector latch arm replacement device with a box shaped mount coupled to the base; and sliding the box shaped mount over a portion of the RJ-type connector.

Yet another step includes providing a box shaped mount having a bottom slot; and inserting a portion of the cable through the slot.

Although the invention has been particularly shown and described with reference to certain embodiments, it will be understood by those skilled in the art that various changes in form and detail may be made without departing from the spirit and scope of the invention.

I claim:

1. A system for repairing an RJ-type connector having locking lugs and the connector coupled to a cable, the RJ-type connector having a broken latch arm, the system comprising:
a forward-facing connector latch arm replacement device comprising
a (dual action) T-piece comprising a T shaped distal end having a narrow waist section linking to the proximal end, and a C-spring coupled to the proximal end whereby the C-spring enables selective deflection of the T-piece whereby the narrow waist selectively engages and disengages the locking lugs provided by the RJ-type connector plug, the C-spring further comprising a base configured offset from and opposite to the distal end; and
a means for coupling the connector latch replacement device to the RJ-type connector, the means comprises the C-spring resiliently pushing on the RJ-type connector.

2. The system of claim 1 wherein the means for coupling the forward facing connector latch replacement device further comprises:
an adhesive strip disposed on an underside of the base of the C spring, whereby the adhesive strip selectively configures to adhere to the RJ-type connector.

3. The system of claim 1 wherein the means for coupling the forward facing connector latch replacement device comprises:
a box coupled to the base of the C spring, the box further comprising a slot at the bottom to facilitate mounting the box over the cable and around the RJ-type connector.

4. The system of claim 1 wherein the means for coupling the forward facing connector latch replacement device further comprises:
a box shaped mount coupled to the base whereby the box shaped mount acts as a downward limiter and thus stops the forward facing latch arm from being pressed too far down and to allow the dual-action T-piece to go below the lugs but not too far down contact the top of the RJ type connector.

5. The system of claim 1 wherein the C-spring further comprises:
a curved leading end coupled to the proximal end of the T-piece.

6. The system of claim 1 wherein the C-spring further comprises:
a clip-on mount coupled to the base.

7. The system of claim 1 wherein the C-spring further comprises:
a bent leading edge coupled to the proximal end of the T-piece.

8. The system of claim 1 wherein the C-spring further comprises:
a section having a short vertical link arm coupled to the proximal end of the T-piece, the section configured to raise the distal end of the forward facing latch arm above the base.

9. The system of claim 1 wherein the C-spring further comprises:
a short reversed angle link arm coupled to the proximal end of the T-piece whereby the short reversed angle link arm raises the distal end of the forward facing latch arm above the base and enabling a longer forward facing latch arm that is easier to press down upon.

10. A method for repairing an RJ-type connector coupled to a cable, the RJ-type connector having a broken latch arm, the method comprising:
providing a forward-facing connector latch arm replacement device comprising a dual-action T-piece comprising a T shaped distal end having a narrow waist section linking to the proximal end, and a C-spring coupled to the proximal end whereby the C-spring enables selective deflection of the T-piece whereby the narrow waist selectively engages and disengages the locking lugs provided by the RJ-type connector plug, the C-spring further comprising a base configured offset from and opposite to the distal end and a means for coupling the connector latch replacement device to the RJ-type connector, the means comprises the C-spring resiliently pushing on the RJ-type connector; and
connecting the forward-facing connector latch to the RJ-connector.

11. The method of claim 10 further comprising:
providing the forward-facing connector latch arm replacement device with an adhesive coupled to the base; and
adhering the base to the RJ-type connector.

12. The method of claim 10 further comprising:
providing the forward-facing connector latch arm replacement device with a box shaped mount coupled to the base; and
sliding the box shaped mount over a portion of the RJ-type connector.

13. The method of claim 10 further comprising:
providing a box shaped mount having a bottom slot; and
inserting a portion of the cable through the slot.
